(19) United States
(12) Patent Application Publication
(10) Pub. No.: US 2008/0219550 A1
(43) Pub. Date: Sep. 11, 2008

(54) LINE DRAWING SEPARATION FOR INDIVIDUAL COLORS

(76) Inventor: TAMOTSU KUSAKA, Shizuoka (JP)

Correspondence Address: NEC CORPORATION OF AMERICA, 6535 N. STATE HWY 161, IRVING, TX, 75039, US

(21) Appl. No.: 12/042,775

(22) Filed: Mar. 5, 2008

(30) Foreign Application Priority Data
Mar. 8, 2007 (JP) 2007-058034

(51) Int. Cl. G06K 9/00

(52) U.S. Cl. 382/164

(57) ABSTRACT

A line drawing region of an image is separated by determining a line drawing region of image data for each of at least one predetermined color using a color determination threshold for the predetermined color; and separating the line drawing region for each predetermined color from a region other than the line drawing region.

This application is based upon and claims the benefit of priority from Japanese Patent Application No. 2007-058034, filed on Mar. 8, 2007, the disclosure of which is incorporated herein in its entirety by reference.

### BACKGROUND OF THE INVENTION

1. Field of the Invention

The present invention relates to image processing technology and, more particularly, to a method for separating a line drawing region from image data, a method for compressing image data, and an image processing apparatus using the same.

2. Description of the Related Art

As digital technology has been developed in recent yeas, multifunctional machines such as color MFPs (MultiFunctional Peripherals), into which a copying machine, scanner, facsimile machine, printer, and the like for digital images are consolidated, have been put in practical use. Since the amount of data is enormous if such a color image is handled as it is, a color image needs to be compressed by using some method before it is communicated or stored. It has been a significant challenge in recent years particularly how to enhance the compression ratio without degrading image quality, and various proposals have been made.

For example, color image compression schemes such as JPEG (Joint Photographic Experts Group) are well known. However, a problem with such a scheme has been pointed out that according to such a scheme, quantization is performed to enhance the compression ratio, which creates a block distortion, resulting in the image in line part and contour part being degraded. A cause for this problem is that common quantization processing is performed on both of an image region requiring high resolution and an image region for which low resolution is good enough, with no consideration given to image properties on a pixel basis. For example, in the case of employing block coding as in the ITU's recommendation T.81, as the compression ratio is increased, apparent image degradation occurs in an area where the spatial frequency is high, such as in line part and contour part.

As a method for solving this problem, an image coding apparatus is proposed which divides an input image into a character-line drawing region and an other-than-line image region and performs coding separately (see Japanese Patent Application Unexamined Publication No. 2002-369010). More specifically, an input image is divided into a line drawing and a other-than-line image. In the line drawing, the resolution property is more significant and little image degradation occurs with respect to the grayscale property even after quantization. In the other-than-line image, reversely, the grayscale property is more significant and little image degradation occurs with respect to the resolution property even after quantization. As to the line drawing, location information, which is concerned with the resolution property, is coded without being quantized, and color information only is quantized and coded. Information regarding the other-than-line image is quantized and coded. As described above, since the resolution property of the line drawing is not quantized, the resolution (spatial frequency) is not degraded. The compression ratio is enhanced by quantizing only the color information of the line drawing.

According to the above-described method of dividing an input image into a character-line drawing region and an other-than-line image region and performing coding separately, attention is focused on the difference in significance between the resolution property and the grayscale property, and compression is performed according to the respective properties, whereby image degradation is avoided and the compression ratio is enhanced. According to this method, an encoder using a multi-value coding scheme, such as entropy coding, is required to compress the color information of a line drawing, causing a problem that the circuit scale is increased.

### SUMMARY OF THE INVENTION

An object of the present invention is to provide a line drawing separation method, image compression method, and image processing apparatus that can enhance the compression ratio without degrading an image.

According to the present invention, a method for separating a line drawing region of an image, includes: determining a line drawing region of image data for each of at least one predetermined color using a color determination threshold for the predetermined color; and separating the line drawing region for each predetermined color from a region other than the line drawing region.

Since the line drawing region is separated for each predetermined color, the image data in the line drawing region for each color can be subjected as binary data to image compression processing. The other region is subjected to image compression processing generally performed. Thus, the compression ratio can be easily enhanced with no image degradation occurring. Moreover, since the image data in the line drawing region for each color can be handled as binary data, a reduction in the circuit scale can also be accomplished.

### BRIEF DESCRIPTION OF THE DRAWINGS

FIG. 1 is a block diagram showing a configuration of a color image processing apparatus according to a first exemplary embodiment of the present invention.

FIG. 2 is a table showing an example of color determination threshold values in the first exemplary embodiment.

FIG. 3 is a flow chart showing an example of line-drawing color determination processing in the first exemplary embodiment.

FIG. 4 is a schematic diagram showing an example of color image data S1.

FIG. 5 is a schematic diagram showing an example of separation result information S2.

FIG. 6A is a schematic diagram showing line-drawing data LC₁, which is the results of the determinations using a color determination threshold value TH₁.

FIG. 6B is a schematic diagram showing line-drawing data LC₂, which is the results of the determinations using a color determination threshold value TH₂.

FIG. 6C is a schematic diagram showing line-drawing data LC₃, which is the results of the determinations using a color determination threshold value TH₃.

FIG. 6D is a schematic diagram showing secondary separation result information S3.

FIG. 7A is a block diagram showing an exemplary configuration of a other-than-line image data generation section in the first exemplary embodiment.

FIG. 7B is a truth table showing the operations of the other-than-line image data generation section.

FIG. 8 is a block diagram showing a configuration of a color image processing apparatus according to a second exemplary embodiment of the present invention.

FIG. 9 is a flow chart showing an example of line-drawing color determination processing according to the second exemplary embodiment.

FIG. 10A is a schematic diagram showing line-drawing data LC₁, which is the results of the determinations using the color determination threshold value TH₁.

FIG. 10B is a schematic diagram showing line-drawing data LC₂, which is the results of the determinations using the color determination threshold value TH₂.

FIG. 10C is a schematic diagram showing line-drawing data LC₃, which is the results of the determinations using the color determination threshold value TH₃.

FIG. 10D is a schematic diagram showing secondary separation result information S3.

FIG. 11A is a block diagram showing an exemplary configuration of a other-than-line image data generation section in the second exemplary embodiment.

FIG. 11B is a table of truth values showing the operations of the other-than-line image data generation section.

### DETAILED DESCRIPTION OF THE PREFERRED EMBODIMENTS

### 1. First Exemplary Embodiment

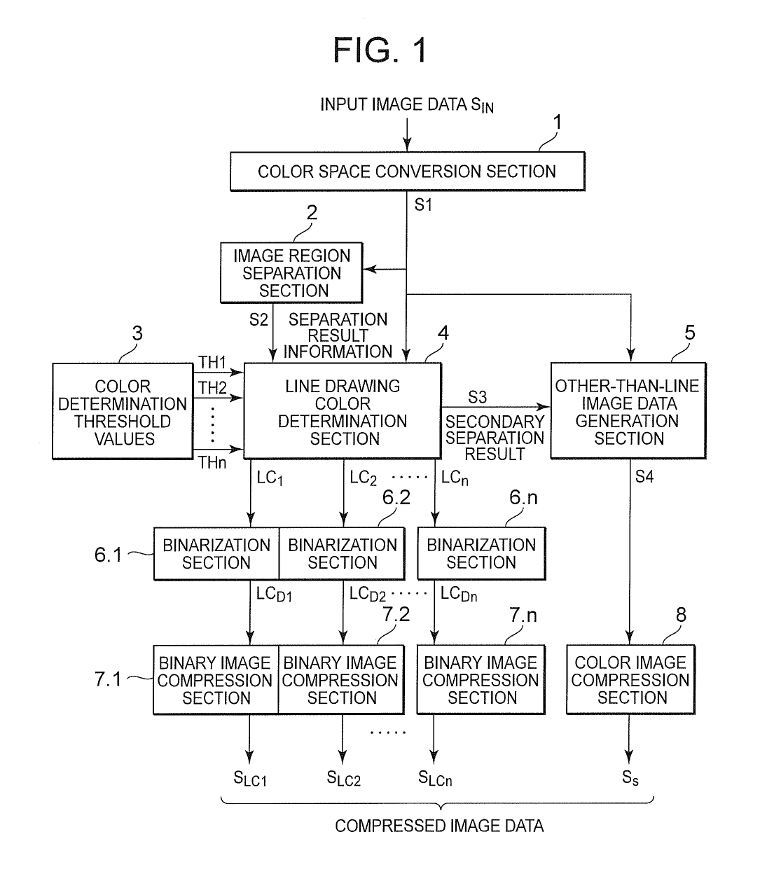

FIG. 1 is a block diagram showing a configuration of a color image processing apparatus according to a first exemplary embodiment of the present invention. Shown here is only the major circuitry related to the present invention.

First, when color original image data S_{IN} is input through an image input section (not shown) such as a color scanner, a color space conversion section 1 makes a conversion to a predetermined color space (e.g., RGB) and outputs image data S1 in the predetermined color space to each of an image region separation section 2, a line drawing color determination section 4, and an other-than-line image data generation section 5.

The image region separation section 2 determines, for each pixel, whether the image data S1 is a line drawing image (e.g., a character image) or an other-than-line image (an image other than the line drawing image), and outputs the results of these determinations as separation result information S2 to the line drawing color determination section 4. For the image data S1, RGB image data, composed of 8 bits for each of the R, G and B components (24 bits in total), is shown here as an example. However, besides the RGB color spaces, data in another color space such as YCbCr, YUV, or Lab can also be applied. The separation result information S2 is binary information (line drawing image/other-than-line image). For each pixel, the image region separation section 2 outputs “1” to the line drawing color determination section 4 when the image data S1 is a line drawing image, and outputs “0” when the image data S1 is a other-than-line image.

The line drawing color determination section 4 compares the image data S1 in the line drawing region with color determination threshold values 3, according to the separation result information S2, and generates line drawing images LC₁ to LCₙ for the respective colors. The color determination threshold values 3 are stored in a memory (not shown). By setting n threshold values TH₁ to THₙ, it is possible to discriminate among n-plane line drawing color data. When performing line drawing color determination, the line drawing color determination section 4 also determines whether or not the line drawing region meets predetermined conditions, and outputs the result of this determination as secondary separation result information S3 to the other-than-line image data generation section 5. The details of the line drawing color determination processing will be described later.

Binarization sections 6.1 to 6.n make binary decisions, on a color basis, on the line drawing images LC₁ to LCₙ respectively, and outputs binarized data LC_{D1} to LC_{Dn}, which are the results of the decisions, to binary image compression sections 7.1 to 7.n respectively. The binarized line drawing image data LC_{D1} to LC_{Dn} are subjected to compression processing by the binary image compression sections 7.1 to 7.n respectively, whereby line drawing color data S_{LC1} to S_{LCn} are generated. For the compression method, a method enabling binary data compression without causing degradation is preferred. For example, run-length encoding such as MH (Modified Huffman), MR (Modified Read) and MMR (Modified Modified Read), arithmetic operation coding such as JBIG (Joint Bi-level Image coding experts Group), or the like can be used.

The other-than-line image data generation section 5 generates other-than-line image data S4 in the region other than the line drawing region from the image data S1, according to the secondary separation result information S3. The other-than-line image data S4 is subjected to compression processing by a color image compression section 8, whereby other-than-line image data Sₛ is generated. Examples of the compression method that can be used include coding algorithms such as JPEG and JPEG2000.

### 1.1) Color Determination Threshold Value

Line drawing color determination for an arbitrary number (n) of colors can be performed by setting n threshold values TH₁ to THₙ as the color determination threshold values 3. Here, description will be given of the case, as an example, where RGB-based three-color (n=3) determination is performed. As mentioned above, the same will hold true in other cases besides RGB, such as YCbCr, YUV, and Lab.

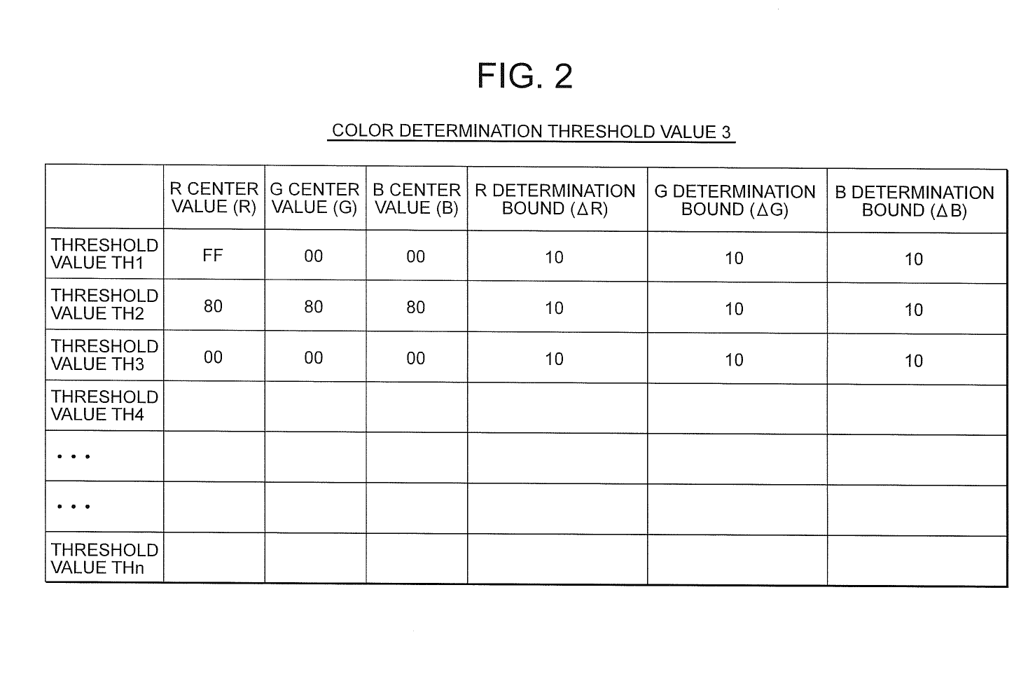

FIG. 2 is a table showing an example of the color determination threshold values in the first exemplary embodiment. Here, three threshold values TH₁ to TH₃ are set in order to perform line drawing color determination for three colors. For each threshold value, three “center values (R, G, B)” and three “determination bounds (ΔR, ΔG, ΔB)” are set for R, G and B respectively as default values. The center value (R/G/B) is a value indicating the center when comparison of a color image is performed with respect to the color of interest. The determination bound (ΔR/ΔG/ΔB) indicates the allowable range of deviation (distance) from its corresponding center value. For example, if the red (R) component of some line drawing image data is within the determination bounds ±ΔR from the center value (R), it is determined that the condition is met with respect to the red (R) component.

According to the example shown in FIG. 2, the threshold value TH₁ represents a color determined by R center value (R)=0xFF (where “0x” indicates hexadecimal notation, and the same will hold true hereinafter), G center value (G)=0x00, and B center value (B)=0x00. As for the allowable range, it is set that R determination bound ΔR=G determination bound ΔG=B determination bound ΔB=10. The threshold value TH₂ represents a color determined by R center value (R)=0x80, G center value (G)=0x80, and B center value (B)=0x80. As for the allowable range, it is set that R determination bound ΔR=G determination bound ΔG=B determination bound ΔB=10. The threshold value TH₃ represents a color determined by R center value (R)=0x00, G center value (G)=0x00, and B center value (B)=0x00. As for the allowable range, it is set that R determination bound ΔR=G determination bound ΔG=B determination bound ΔB=10. A desired number of color determination threshold values can be set by similarly further designating center values and determination bounds.

Using such color determination threshold values 3, the line drawing color determination section 4 performs line drawing color determination on the image data S1 in the line drawing region.

### 1.2) Line Drawing Color Determination Processing

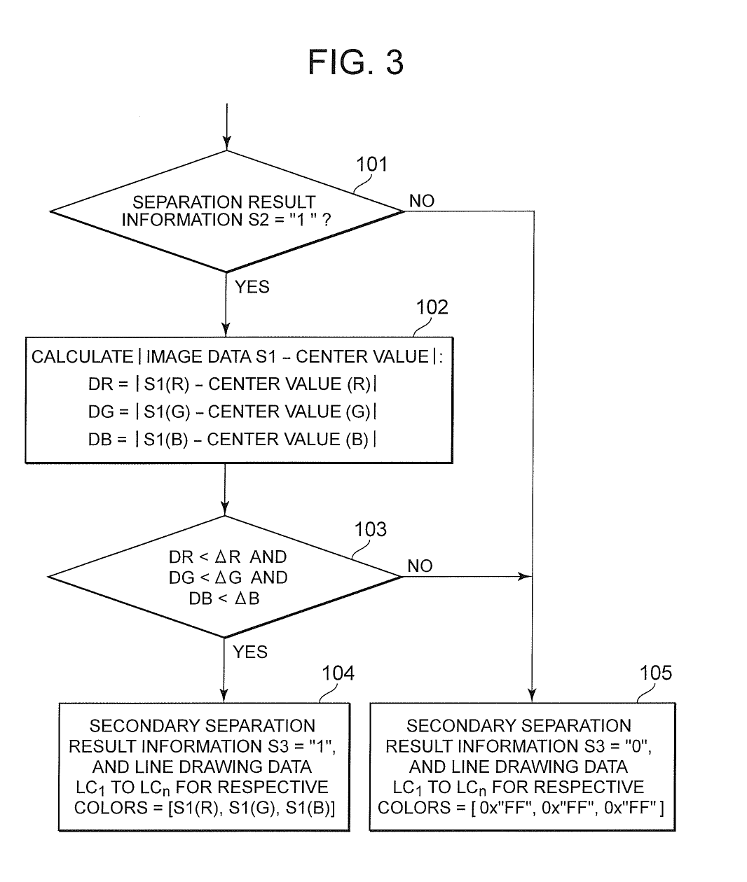

FIG. 3 is a flow chart showing an example of the line drawing color determination processing in the first exemplary embodiment. First, the line drawing color determination section 4 receives as input the separation result information S2, image data S1, and color determination threshold values 3. Then, for each pixel, the line drawing color determination section 4 determines whether or not the separation result information S2 is “1” (line drawing) (Step 101). When the separation result information S2=1 (Step 101: YES), the line drawing color determination section 4 makes the pixel in question a candidate pixel for the line drawing image and, with respect to each of the color determination threshold values TH₁ to THₙ, calculates the absolute values DR, DG, and DB of the differences between the image data S1 in this candidate pixel and the individual center values (R, G, B) of the threshold value by using the following equations (Step 102).

DR=|R value of image data S1−center value (R)|

DG=|G value of image data S1−center value (G)|

DB=|B value of image data S1−center value (B)|

Subsequently, the line drawing color determination section 4 determines whether or not all of the following conditions (1) to (3) are met, that the results of the calculations, DR, DG, and DB, are smaller than the determination bounds ΔR, ΔG, and ΔB respectively (Step 103).

DR<ΔR Condition (1)

DG<ΔG Condition (2)

DB<ΔB Condition (3)

When the conditions (1) to (3) are all met (Step 103: YES), the line drawing color determination section 4 outputs RGB components of the image data S1 as each of the line drawing data LC₁ to LCₙ (here, n=3) and also outputs the secondary separation result information S3=1 (line drawing)” to the other-than-line image data generation section 5 (Step 104). When the separation result information S2=0 (Step 101: NO), or when at least one of the conditions (1) to (3) is not met (Step 103: NO), the line drawing color determination section 4 outputs R=G=B=0xFF as mask values of each of the line drawing data LC₁ to LCₙ (here, n=3) and also outputs the secondary separation result information S3=0 (image other than line drawing) to the other-than-line image data generation section 5 (Step 105).

The line drawing data LC₁ to LCₙ for the respective colors thus output from the line drawing color determination section 4 are compared with predetermined threshold values by the binarization sections 6.1 to 6.n respectively, whereby each data is binarized. In this example, the data in the pixels with the result that R=G=B=0xFF are converted to “0”, and the data in the other pixels are converted to “1” because it is determined by the line drawing color determination section 4 that these pixels have the colors. The binarized line drawing data LC_{D1} to LC_{Dn} thus obtained through the binarization on a color basis are compressed by the binary image compression sections 7.1 to 7.n respectively.

### 1.3) Specific Example

Next, a specific example of the above-described line drawing color determination processing will be described by taking the case, as an example, where the color determination threshold values TH₁ to TH₃ corresponding to three colors (n=3) shown in FIG. 2 are set.

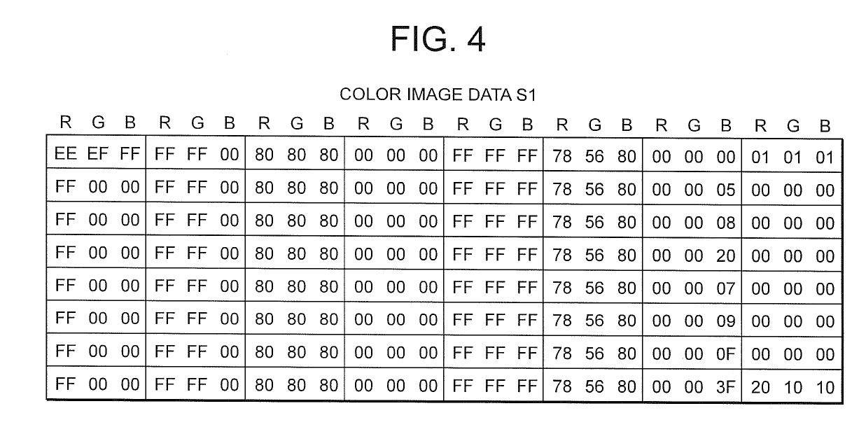

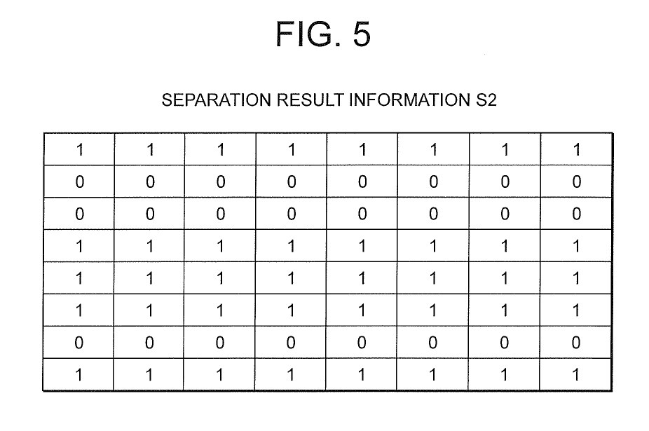

FIG. 4 is a schematic diagram showing an example of the color image data S1, and FIG. 5 is a schematic diagram showing an example of the separation result information S2. It is assumed that such image data S1 and separation result information S2 are given to the line drawing color determination section 4. In this example, the image data S1 and the separation result information S2 are each composed of 8 pixels×8 pixels. Referring to FIG. 4, when (R, G, B)=(EE EF FF) as the top-left pixel in the image data S1 shows, it indicates that R=0xEE, G=0xEF, and B=0xFF. Additionally, in FIG. 5, a pixel with “1” (separation result information S2) indicates a line drawing image, and a pixel with “0” indicates an other-than-line image.

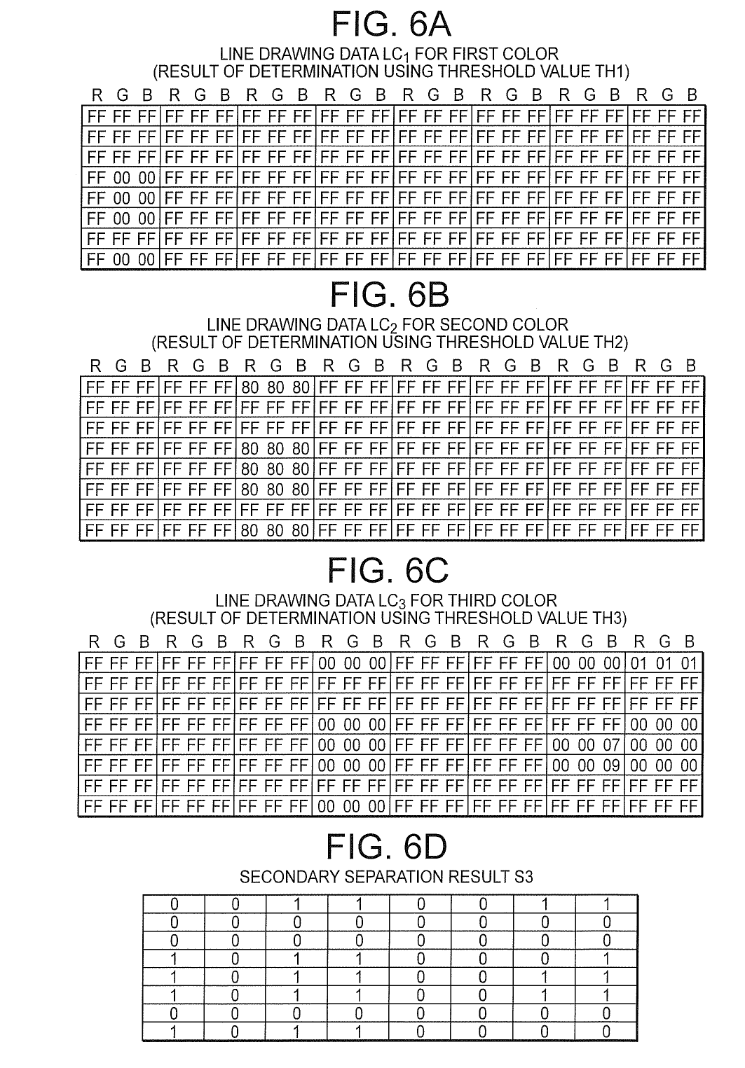

The line drawing color determination section 4 receives as input the color determination threshold values TH₁ to TH₃ shown in FIG. 2, the image data S1 shown in FIG. 4, and the separation result information S2 shown in FIG. 5, and performs the logical operation shown in FIG. 3 for each pixel, thereby generating the line drawing data LC₁ to LC₃ as shown in FIGS. 6A to 6C, corresponding to the color determination threshold values TH₁ to TH₃ respectively, and the secondary separation result information S3 as shown in FIG. 6D.

FIG. 6A is a schematic diagram showing the line drawing data LC₁, which is the results of the determinations using the color determination threshold value TH₁. Since the color determination threshold value TH₁ has the center values (R, G, B)=(FF, 00, 00), there remain only pixel data for which it is determined that the data is within the determination bounds and has the color of interest, and the other pixels are masked with the mask values (R, G, B)=(FF, FF, FF). Note that masking is done here so that each of the R, G and B values will be “0xFF”, that is, the pixel will be white. However, as for the mask values themselves, since it is sufficient to select values which do not affect the subsequent binarization by the binarization sections 6.1 to 6.n, the mask values are not limited to “0xFF”. The same will hold true hereinafter.

FIG. 6B is a schematic diagram showing the line drawing data LC₂, which is the results of the determinations using the color determination threshold value TH₂. Since the color determination threshold value TH₂ has the center values (R, G, B)=(80, 80, 80), there remain only pixel data for which it is determined that the data is within the determination bounds and has the color of interest, and the other pixels are masked with the mask values (R, G, B)=(FF, FF, FF).

FIG. 6C is a schematic diagram showing the line drawing data LC₃, which is the results of the determinations using the color determination threshold value TH₃. Since the color determination threshold value TH₃ has the center values (R, G, B)=(00, 00, 00), there remain only pixel data for which it is determined that the data is within the determination bounds and has the color of interest, and the other pixels are masked with the mask values (R, G, B)=(FF, FF, FF).

FIG. 6D is a schematic diagram showing the secondary separation result information S3. If it is determined, with respect to any one of the colors, that the data in a pixel is within the determination bounds and has the color of interest, then the secondary separation result information S3=“1” is stored for that pixel (Step 104 in FIG. 3). Therefore, resultantly, the secondary separation result information S3 is the results of carrying out the logical OR on each pixel, and the secondary separation result information S3 as shown in FIG. 6D can be obtained.

This secondary separation result information S3 is what is obtained by further performing separation determination on the decisions represented by the separation result information S2, as shown at Step 103 in FIG. 3. As a result, more accurate separation between the line drawing and the other-than-line image can be accomplished. The undermentioned other-than-line image data generation is performed by using such secondary separation result information S3, whereby more accurate compression with no image degradation can be achieved.

### 1.4) Other-Than-Line Image Data Generation Section

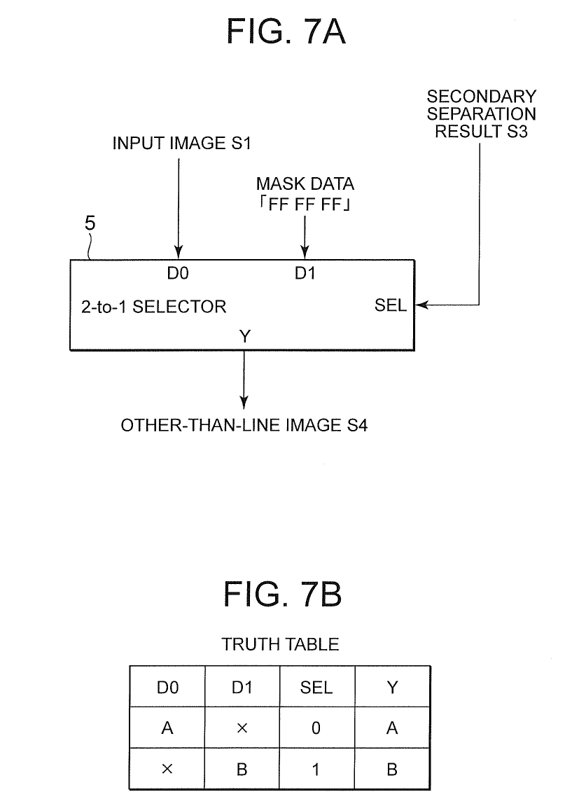

FIG. 7A is a block diagram showing an exemplary configuration of the other-than-line image data generation section in the first exemplary embodiment, and FIG. 7B is a truth table showing the operations thereof. Since the other-than-line image data generation section 5 extracts the other-than-line image region from the image data S1 according to the secondary separation result information S3, the other-than-line image data generation section 5 can be configured by using a 2:1 selector. Specifically, the other-than-line image data generation section 5 is configured so that the image data S1 and the mask data are input to a first input D0 and a second input D1 of the selector respectively and the secondary separation result information S3 is input to a selective terminal SEL.

Then, when the secondary separation result information S3 is “0” (other-than-line image region), the image data S1 input to the first input D0 is output as the other-than-line image S4 from an output Y, and when the secondary separation result information S3 is “1” (line drawing region), the mask data (which is “FF FF FF” corresponding to white data in this example) input to the second input D1 is output as the other-than-line image S4 from the output Y.

In this manner, the other-than-line image data generation section 5 outputs the input image data S1 when determining that the data in question is an other-than-line image, and outputs the mask values when determining that the data in question is a line drawing.

### 1.5) Advantages

As described above, according to the first exemplary embodiment of the present invention, for each color, line drawing data is extracted, subjected to binarization processing, and then compressed by using a coding scheme which causes no image degradation. Thereby, it is possible to avoid image degradation in the line drawing part and contour part. In addition, for the other-than-line image region, it is possible to perform compression at a high compression ratio by using a color image compression scheme. The compressed image data thus obtained is stored in a memory, or transmitted through a communication link.

Moreover, since the line drawing data is binarized with a color specified, it is possible to use, for the scheme of coding the line drawing, a coding scheme which can be implemented with a small circuit scale. This enables the simplification of the circuitry of the line drawing color determination section.

Furthermore, it is possible to further enhance the compression ratio without degrading, for example, character information in the line drawing region, by allowing the line drawing color determination section 4 and the other-than-line image data generation section 5 to vary the resolutions of the line drawing region and the other-than-line image region respectively.

### 2. Second Exemplary Embodiment

According to the first exemplary embodiment, as shown in FIG. 1, the line drawing color determination section 4 performs line drawing color determination and generates the secondary separation result information S3 by using the separation result information S2 obtained by the image region separation section 2. However, the present invention is not limited to this.

According to a second exemplary embodiment of the present invention, which will be described next, a line drawing color determination section performs line drawing color determination and generates the secondary separation result information S3 without using the separation result information S2 obtained by the image region separation section 2, and an other-than-line image data generation section generates the other-than-line image data S4 by using the separation result information S2 and the secondary separation result information S3. It is determined here whether or not an other-than-line image is an edge, depending on the combination of the values of the separation result information S2 and the secondary separation result information S3. Hereinafter, the secondary exemplary embodiment will be described. However, description of those parts overlapping with the first exemplary embodiment will be omitted as deemed appropriate.

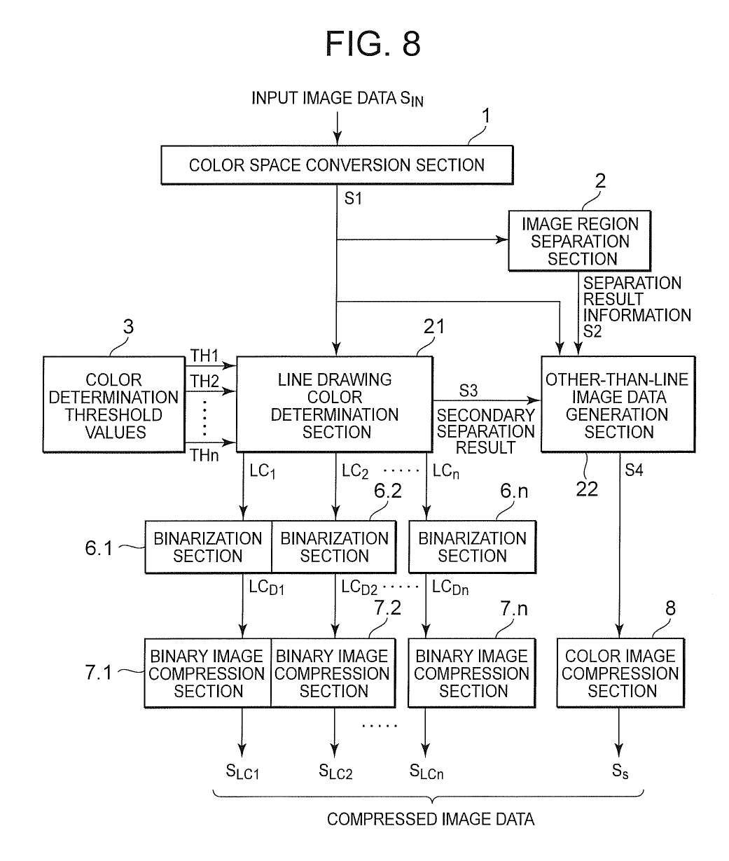

FIG. 8 is a block diagram showing a configuration of a color image processing apparatus according to the second exemplary embodiment of the present invention. Note that those blocks having the same functions as in the first exemplary embodiment are given the same reference numerals and description thereof will be omitted. Major different points of the second exemplary embodiment from the first exemplary embodiment are that a line drawing color determination section 21 performs line drawing color determination and generates the secondary separation result information S3 without using the separation result information S2 obtained by the image region separation section 2, and that an other-than-line image data generation section 22 generates the other-than-line image data S4 by using the separation result information S2. Accordingly, hereinafter, description will be given mainly of the line drawing color determination section 21 and the other-than-line image data generation section 22.

The line drawing color determination section 21 compares image data S1 with color determination threshold values 3 and generates line drawings LC₁ to LCₙ for the respective colors. In addition, the line drawing color determination section 21 outputs secondary separation result information S3 to the other-than-line image data generation section 22. The color determination threshold values 3 are as described in the above Section 1.1, and therefore description of the individual values will be omitted. The binarization sections 6.1 to 6.n make binary decisions, on a color basis, on the line drawings LC₁ to LCₙ respectively and outputs binarized data LC_{D1} to LC_{Dn}, which are the results of the decisions, to the binary image compression sections 7.1 to 7.n respectively.

The other-than-line image data generation section 22 generates other-than-line image data S4 in the region other than the line drawing region from the image data S1, according to separation result information S2 and the secondary separation result information S3. The other-than-line image data S4 is subjected to compression processing by the color image compression section 8, whereby other-than-line image data Sₛ is generated.

### 2.1) Line Drawing Color Determination Processing

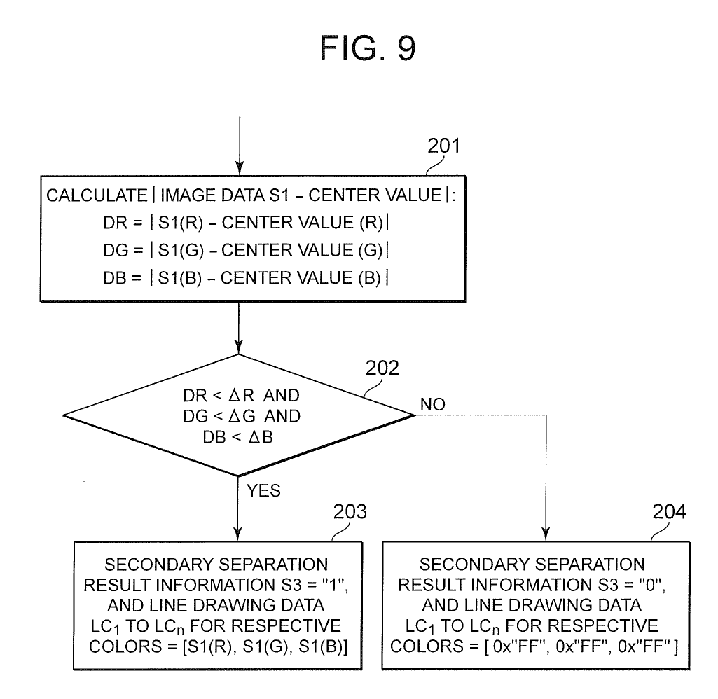

FIG. 9 is a flow chart showing an example of the line drawing color determination processing in the second exemplary embodiment. First, the line drawing color determination section 21 receives as input the image data S1 and the color determination threshold values 3. Then, for each pixel, the line drawing color determination section 21 calculates, with respect to each of the color determination threshold values TH₁ to THₙ, the absolute values DR, DG, and DB of the differences between the image data S1 in the pixel in question and the individual center values (R, G, B) of the threshold value by using the following equations (Step 201).

DR=|R value of image data S1−center value (R)|

DG=|G value of image data S1−center value (G)|

DB=|B value of image data S1−center value (B)|

Subsequently, the line drawing color determination section 21 determines whether or not all of the following conditions (1) to (3) are met, the conditions that the results of the calculations, DR, DG, and DB, are smaller than the determination bounds ΔR, ΔG, and ΔB respectively (Step 202).

DR<ΔR Condition (1)

DG<ΔG Condition (2)

DB<ΔB Condition (3)

When the conditions (1) to (3) are all met (Step 202: YES), the line drawing color determination section 21 outputs RGB components of the image data S1 as each of the line drawing data LC₁ to LCₙ (here, n=3) and also outputs the secondary separation result information S3=1 (line drawing)” to the other-than-line image data generation section 22 (Step 203). When at least one of the conditions (1) to (3) is not met (Step 202: NO), the line drawing color determination section 21 outputs R=G=B=0xFF as mask values of each of the line drawing data LC₁ to LCₙ (here, n=3) and also outputs the secondary separation result information S3=0 (image other than line drawing) to the other-than-line image data generation section 22 (Step 204).

The line drawing data LC₁ to LCₙ for the respective colors thus output from the line drawing color determination section 21 are compared with predetermined threshold values by the binarization sections 6.1 to 6.n respectively, whereby each data is binarized. In this example, the data in the pixels with the result that R=G=B=0xFF are converted to “0”, and the data in the other pixels are converted to “1” because it is determined by the line drawing color determination section 21 that these pixels have the colors. The binarized line drawing data LC_{D1} to LC_{Dn} thus obtained through the binarization on a color basis are compressed by the binary image compression sections 7.1 to 7.n respectively.

### 2.2) Specific Example

Next, a specific example of the above-described line drawing color determination processing will be described by taking the case, as an example, where the color determination threshold values TH₁ to TH₃ corresponding to three colors (n=3) shown in FIG. 2 are set and the color image data S1 shown in FIG. 4 is given to the line drawing color determination section 21.

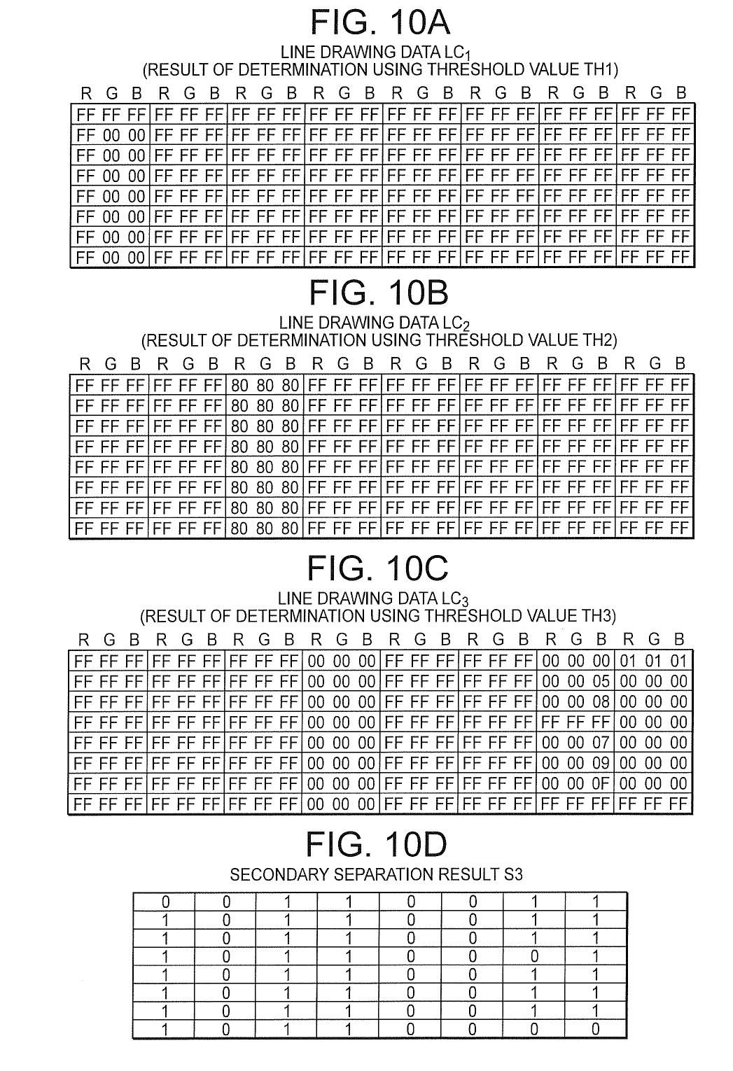

The line drawing color determination section 21 receives as input the color determination threshold values TH₁ to TH₃ shown in FIG. 2 and the image data S1 shown in FIG. 4, and performs the logical operation shown in FIG. 9 for each pixel, thereby generating the line drawing data LC₁ to LC₃ as shown in FIGS. 10A to 10C, corresponding to the color determination threshold values TH₁ to TH₃ respectively, as well as the secondary separation result information S3.

FIG. 10A is a schematic diagram showing the line drawing data LC₁, which is the results of the determinations using the color determination threshold value TH₁. Since the color determination threshold value TH₁ has the center values (R, G, B)=(FF, 00, 00), there remain only pixel data for which it is determined that the data is within the determination bounds and has the color of interest, and the other pixels are masked with the mask values (R, G, B)=(FF, FF, FF). Note that masking is done here so that each of the R, G, and B values will be “0xFF”, that is, the pixel will be white. However, as for the mask values themselves, it is sufficient to select values that do not affect the subsequent binarization by the binarization sections 6.1 to 6.n. Therefore, the mask values are not limited to “0xFF”. The same will hold true hereinafter.

FIG. 10B is a schematic diagram showing the line drawing data LC₂, which is the results of the determinations using the color determination threshold value TH₂. Since the color determination threshold value TH₂ has the center values (R, G, B)=(80, 80, 80), there remain only pixel data for which it is determined that the data is within the determination bounds and has the color of interest, and the other pixels are masked with the mask values (R, G, B)=(FF, FF, FF).

FIG. 10C is a schematic diagram showing the line drawing data LC₃, which is the results of the determinations using the color determination threshold value TH₃. Since the color determination threshold value TH₃ has the center values (R, G, B)=(00, 00, 00), there remain only pixel data for which it is determined that the data is within the determination bounds and has the color of interest, and the other pixels are masked with the mask values (R, G, B)=(FF, FF, FF).

FIG. 10D is a schematic diagram showing the secondary separation result information S3. If it is determined, with respect to any one of the colors, that the data in a pixel is within the determination bounds and has the color of interest, then the secondary separation result information S3=“1” is stored for that pixel (Step 203 in FIG. 9). Therefore, resultantly, the secondary separation result information S3 is the results of carrying out the logical OR on each pixel, and the secondary separation result information S3 as shown in FIG. 10D can be obtained.

This secondary separation result information S3, unlike the secondary separation result information S3 in the first exemplary embodiment, is what is obtained by comparing between the image data S1 and each of the color determination threshold values TH₁ to TH₃, and therefore has not gone through the screening using the separation result information S2. As a result, the separation between the line drawing and the other-than-line image is different from that in the first exemplary embodiment shown in FIG. 6D.

### 2.3) Other-Than-Line Image Data Generation Section

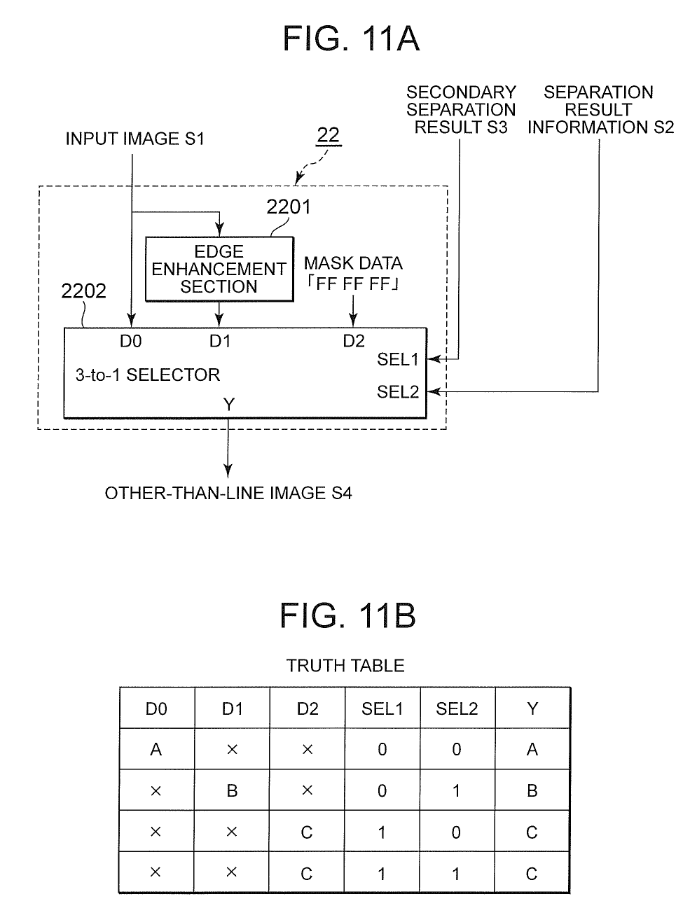

FIG. 11A is a block diagram showing an exemplary configuration of the other-than-line image data generation section in the second exemplary embodiment, and FIG. 11B is a truth table o showing the operations thereof. The other-than-line image data generation section 22 is composed of an edge enhancement section 2201 and a 3:1 selector 2202. The edge enhancement section 2201 performs edge enhancement processing on an arbitrary pixel of the image data S1 while referring to those pixels surrounding the arbitrary pixel, and generates image data in which an edge is enhanced.

The 3:1 selector 2202 is configured so that the image data S1, the edge-enhanced image data from the edge enhancement section 2201, and the mask data are input to a first input D0, a second input D1, and a third input D2 respectively and the secondary separation result information S3 and the separation result information S2 are input to a first selective terminal SEL1 and a second selective terminal SEL2 respectively. As described already, for each pixel, the image region separation section 2 outputs the separation result information S2=“1” when the data in question is a line drawing, and outputs the separation result information S2=“0” when the data in question is a other-than-line image. In addition, the line drawing color determination section 21 outputs the secondary separation result information S3=“0” when determining that the data in question is in the other-than-line image region, and outputs the secondary separation result information S3=“1” when determining that the data in question is in the line drawing region.

According to the second exemplary embodiment, as shown in FIG. 11B, when the secondary separation result information S3 input to the first selective terminal SEL1 is “1” and it is determined that the data in question is in the line drawing region, then, regardless of the value of the separation result information S2 input to the second selective terminal SEL2, it is determined that the data in question is in the line drawing region. The 3:1 selector 2202 outputs the mask data (which is “FF FF FF” corresponding to white data in this example) input to the third input D2 from an output Y as the other-than-line image S4. When the secondary separation result information S3 input to the first selective terminal SEL1 is “0” and it is determined that the data in question is in the other-than-line image region, and also when the separation result information S2 input to the second selective terminal SEL2 is “0” and it is similarly determined that the data in question is in the other-than-line image region, then the 3:1 selector 2202 outputs the image data S1 input to the first input D0 from the output Y as the other-than-line image S4.

On the other hand, when the secondary separation result information S3 input to the first selective terminal SEL1 is “0” and it is determined that the data in question is in the other-than-line image region, but when the separation result information S2 input to the second selective terminal SEL2 is “1” and it is determined that the data in question is in the line drawing region, then the 3:1 selector 2202 outputs the edge-enhanced image data input to the second input D1 from the output Y as the other-than-line image S4. As described above, when the secondary separation result information S3 indicates a other-than-line image region determination and the separation result information S2 indicates a line drawing region determination, then, although abiding by the other-than-line image region determination, it is determined that the data is in a contour part of the other-than-line image region, and the other-than-line image data in which the edge is enhanced is output.

### 2.4) Advantages

As described above, according to the second exemplary embodiment, for each color, line drawing data is extracted, subjected to binarization processing, and compressed by using a coding scheme which causes no image degradation, as in the first exemplary embodiment. Thereby, it is possible to avoid image degradation in the line drawing part and contour part. Moreover, for the other-than-line image region, it is possible to perform compression at a high compression ratio by using a color image compression scheme. The compressed image data thus obtained is stored in a memory, or transmitted through a communication link. Since the line drawing data is binarized with a color specified, it is possible to use, for the scheme of coding the line drawing, a coding scheme which can be implemented with a small circuit scale. This enables the simplification of the circuitry of the line drawing color determination section. Additionally, it is possible to further enhance the compression ratio without degrading, for example, character information in the line drawing region, by allowing the line drawing color determination section 21 and the other-than-line image data generation section 22 to vary the resolutions of the line drawing region and the other-than-line image region respectively.

Furthermore, according to the second exemplary embodiment, it is possible to detect contour part of the other-than-line image and perform edge enhancement processing. This enables the compression of the other-than-line image in a good condition.

### 3. Third Exemplary Embodiment

In the color image processing apparatuses according to the first and second exemplary embodiments shown in FIGS. 1 and 8 respectively, the color space conversion section 1, image region separation section 2, line drawing color determination section 4 or 21, other-than-line image data generation section 5 or 22, binarization sections 6.1 to 6.n, binary image compression sections 7.1 to 7.n, and color image compression section 8 can be implemented by hardware. However, they can also be implemented by executing programs corresponding the respective functions on a program-controlled processor. Regarding the line drawing color determination section and the other-than-line image data generation section in particular, the line drawing color determination section 4 and the other-than-line image data generation section 5 in the first exemplary embodiment can be implemented by using programs which implement the functions shown in FIGS. 3 and 7, and the line drawing color determination section 21 and the other-than-line image data generation section 22 in the second exemplary embodiment can be implemented by using programs which implement the functions shown in FIGS. 9 and 11.

Moreover, as to the n binarization sections 6.1 to 6.n and the n binary image compression sections 7.1 to 7.n shown in FIGS. 1 and 8, their equivalent functions can be implemented in such a manner that one binarization section and one binary image compression section perform binarization processing and binary image compression processing for each color under time division control. Alternatively, it is also possible to make a configuration such that the line drawing color determination section 4/21 and the binarization sections 6.1 to 6.n are implemented by executing programs on a program-controlled processor, whereby line drawing data LC_{D1} to LC_{Dn} binarized on a color basis are obtained, and then the binarized line drawing data LC_{D1} to LC_{Dn} are compressed by the binary image compression sections 7.1 to 7.n respectively.

### 4. Various aspects

As described above, the present invention can provide a line drawing separation method, image compression method, and image processing apparatus that can enhance the compression ratio without degrading an image. Further, the present invention can provide a line drawing separation method, image compression method, and image processing apparatus that can reduce the circuit scale.

According to an aspect of the present invention the following steps may be provided: determining a line drawing region for each predetermined color in image data by using a color determination threshold value set for at least one predetermined color; and separating the line drawing region for each predetermined color from the other region.

Since the line drawing region is separated for each predetermined color, the image data in the line drawing region for each color can be subjected as binary data to image compression processing. The other region is subjected to image compression processing generally performed. Thus, the compression ratio can be easily enhanced with no image degradation occurring. Moreover, since the image data in the line drawing region for each color can be handled as binary data, a reduction in the circuit scale can also be accomplished.

Image degradation in line part and contour part can be avoided by extracting, for example, data in the line part, subjecting the data in the line part to binarization processing, and compressing the binarized data in the line part by using a coding scheme which causes no image degradation. Other-than-line image part can be compressed at a high compression ratio by using a color image compression scheme. Moreover, as to the line drawing data, a color is specified and then the line drawing data is binarized. Accordingly, for the scheme of coding the line drawing, it is possible to use a coding scheme which can be implemented with a small circuit scale. In addition, by specifying a color, it is possible to simplify the circuitry of the line drawing color determination section.

In an image processing apparatus according to an example of the present invention, after image data input from a color scanner is converted into a predetermined color space, separation result information indicating a character-line drawing region and an other-than-line image region (the region other than the character-line drawing region) is output. While the color of the line drawing is compared with each color determination threshold value by using the separation result information, line drawing color determination is performed. A line drawing region thus obtained through the line drawing color determination is output as secondary separation result information. At the same time, plane information for each specific color is output as line drawing data. Using the secondary separation result information, a other-than-line image data generation section of the image processing apparatus generates other-than-line image data after separation. On the other hand, the line drawing data for each specific color is binarized to become line drawing color plane information. This line drawing color plane information and the other-than-line image data after separation are individually subjected to compression processing by using predetermined compression schemes, and then subjected to subsequent-stage processing such as data communication and data storage. By generating a character information plane for specific-color data as described above, it is possible to compress the line drawing information such as a character without degrading the image. Moreover, it is possible to further enhance the compression ratio without degrading the character information, if the resolutions of the line drawing information and the other-than-line image information are varied.

The present invention can be applied to digital-based image compression apparatuses, image storage and reproduction apparatuses, color image processing apparatuses, color image formation apparatuses, and the like, such as printers, facsimile machines, copying machines, and multifunction peripherals.

The present invention may be embodied in other specific forms without departing from the spirit or essential characteristics thereof. The above-described exemplary embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A method for separating a line drawing region of an image, comprising:
determining a line drawing region of image data for each of at least one predetermined color using a color determination threshold for the predetermined color; and
separating the line drawing region for each predetermined color from a region other than the line drawing region.

2. A method for compressing image data, comprising:
a) determining a line drawing region of image data for each of at least one predetermined color using a color determination threshold for the predetermined color;
b) compressing the line drawing region for each predetermined color by binary image compression; and
c) compressing a region other than the line drawing region by color image compression.

3. The method according to claim 2, wherein a) comprises:
separating a first line drawing region of the image data; and
determining the line drawing region for each predetermined color from image data of the first line drawing region by using the color determination threshold of the predetermined color.

4. The method according to claim 2, wherein in the c), the region is compressed according to first separation information and second separation information, wherein the first separation information is used to separate a first line drawing region of the image data and the second separation information is used to determine the line drawing region for each predetermined color in the a).

5. The method according to claim 4, wherein the c) comprises:
enhancing edges of a region which is the first line drawing region determined by the first separation information and the region other than the line drawing region for each predetermined color; and
compressing the region subjected to edge enhancement by the color image compression.

6. A device for processing image data, comprising:
a separation section for determining a line drawing region of the image data for each of at least one predetermined color using a color determination threshold for the predetermined color;
a first image processor for processing image data of the line drawing region for each predetermined color; and
a second image processor for processing image data of a region other than the line drawing region.

7. The device according to claim 6, wherein the separation section comprises:
a first separation section for separating a first line drawing region of the image data; and
a second separation section for determining the line drawing region for each predetermined color from image data of the first line drawing region by using the color determination threshold of the predetermined color.

8. The device according to claim 6, wherein the separation section generates first separation information which is used to separate a first line drawing region of the image data and second separation information which is used to determine the line drawing region for each predetermined color, and
the second image processor uses the first separation information and the second separation information to process the image data of the region other than the line drawing region.

9. The device according to claim 6, wherein the second image processor includes an edge enhancement section for enhancing edges of a region which is the first line drawing region determined by the first separation information and the region other than the line drawing region for each predetermined color.

10. The device according to claim 6, wherein the first image processor comprises:
a binarization section for binarizing image data of the line drawing region for each predetermined color; and
a compression section for compressing the binarized image data.

11. The device according to claim 6, wherein the second image processor compresses a region other than the line drawing region by color image compression.

12. A program for instructing a computer of an image processing device to process image data, comprising the steps of:
determining a line drawing region of the image data for each of at least one predetermined color using a color determination threshold for the predetermined color;
processing image data of the line drawing region for each predetermined color; and
processing image data of a region other than the line drawing region.

13. A program for instructing a computer of an image processing device to process image data, comprising the steps of:
determining a line drawing region of the image data for each of at least one predetermined color using a color determination threshold for the predetermined color;
compressing the line drawing region for each predetermined color by binarized image compression; and
compressing a region other than the line drawing region by color image compression.
